(19) United States
(12) Patent Application Publication
(10) Pub. No.: US 2026/0163293 A1
(43) Pub. Date: Jun. 11, 2026

(54) PRESS-FIT CONNECTOR WITH MODULAR COMPONENTS

(71) Applicant: Ennovi Industries, Inc., East Providence, RI (US)

(72) Inventors: Matthew Rumschlag, Hawthorn Woods, IL (US); Jason Ksiazk, Arlington Heights, IL (US); Richard Johannes, Santa Rosa, CA (US); Richard Schneider, Livonia, MI (US); Gregory Torigian, Garnerville, NY (US)

(21) Appl. No.: 18/709,270

(22) PCT Filed: Oct. 19, 2022
(86) PCT No.: PCT/US2022/047130

§ 371 Date: May 10, 2024

Related U.S. Application Data
(60) Provisional application No. 63/280,219, filed on Nov. 17, 2021.

(51) Int. Cl. H01R 13/514; H01R 12/70

(52) U.S. Cl. CPC H01R 13/514; H01R 12/7017

(57) ABSTRACT

A connector assembly for connecting together parts to convey electrical signals in-between. The connector assembly includes a plurality of terminal wafers mechanically connected together. Each of the terminal wafers includes a plurality of terminals, each having oppositely directed press-fit fasteners. A body formed from plastic is molded over the terminals. The terminal wafers are connected together by having plugs of one or more terminal wafers inserted into sockets of one or more other terminal wafers, respectively.

### CROSS-REFERENCE TO RELATED APPLICATION(S)

This application claims the benefit of priority under 35 U.S.C. § 119(e) to U.S. Provisional Patent Application No.: 63/280,219 filed on 17 Nov. 2021, which is herein incorporated by reference.

### TECHNICAL FIELD

This disclosure relates generally to electrical connectors for connecting together electrical/electronic devices or parts.

### BACKGROUND

Connectors, are widely used to interconnect electrical/electronic devices or parts. One common application is connecting together a pair of printed circuit boards (PCBs). In such an application, a connector may utilize a plurality of terminals, each having at least one end portion that is to be fixed in an electrically conductive (plated) hole of one of the PCBs. Such an end portion may be secured within the plated hole by soldering or by a resilient fastener. In the latter instance, the resilient fastener is typically referred to as a press-fit fastener.

Some connectors utilize terminals having opposing first and second end portions with press-fit fasteners. In such a connector, the press-fit fasteners of the first end portions are secured in holes of a first PCB and the press-fit fasteners of the second end portions are secured in holes of a second PCB. These connectors conventionally have a fixed pin count, i.e., a fixed number of terminals. In order to increase the pin count, a different connector must be provided. Typically, connectors with different pin counts have different constructions and utilize different components. Thus, a manufacturer of connectors must stock a unique set of components for each connector it makes. In order for a manufacturer to reduce its inventory of components, it would be desirable to have connectors of different pin counts to share as many components as possible. The present disclosure is directed to such connectors and a method of producing the same.

### SUMMARY

In accordance with the disclosure, a connector assembly is provided for connecting together parts to convey electrical signals in-between. The connector assembly includes a plurality of terminal wafers mechanically connected together. Each of the terminal wafers includes a plurality of terminals. Each terminal has a first press-fit fastener joined to a second press-fit fastener by a linearly-extending main section such that the first and second press-fit fasteners extend in opposing directions. A body formed from plastic is molded over the terminals. The body has first and second sides extending between first and second ends. The first side has a plurality of sockets and the second side has a plurality of outwardly-extending plugs. The first press-fit fasteners project from the first end of the body and the second press-fit fasteners project from the second end of the body. The terminal wafers are connected together by having the plugs of one or more terminal wafers inserted into the sockets of one or more other terminal wafers, respectively.

### BRIEF DESCRIPTION OF THE DRAWINGS

The features, aspects, and advantages of the present invention will become better understood with regard to the following description, appended claims, and accompanying drawings where:

FIG. 1 is a front perspective view of a connector assembly constructed in accordance with the present disclosure;

FIG. 2 is a rear perspective view of the connector assembly of FIG. 1;

FIG. 3 is a bottom plan view of the connector assembly of FIG. 1;

FIG. 4 is a front plan view of the connector assembly of FIG. 1;

FIG. 5 is a front perspective view of a terminal wafer of the connector assembly of FIG. 1;

FIG. 6 is a front plan view of terminals of the terminal wafer of FIG. 5, wherein some of the terminals are not shown for better illustration;

FIG. 7 is a close-up view of a portion of the terminal wafer of FIG. 5, with one of the terminals removed to better show features of a socket;

FIG. 8 is a front perspective view of a connector assembly constructed in accordance with a second embodiment of the present disclosure; and

FIG. 9 is a front elevational view of the connector assembly of FIG. 8 connecting together upper and lower PCBs.

### DETAILED DESCRIPTION OF ILLUSTRATIVE EMBODIMENTS

It should be noted that in the detailed description that follows, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

Spatially relative terms, such as “top”, “bottom”, “lower”, “above”, “upper”, and the like, are used herein merely for ease of description to describe one element or feature's relationship to another element(s) or feature(s) as they are illustrated in (a) drawing figure(s) being referred to. It will be understood that the spatially relative terms are not meant to be limiting and are intended to encompass different orientations of the device in use or operation in addition to the orientation depicted in the drawings.

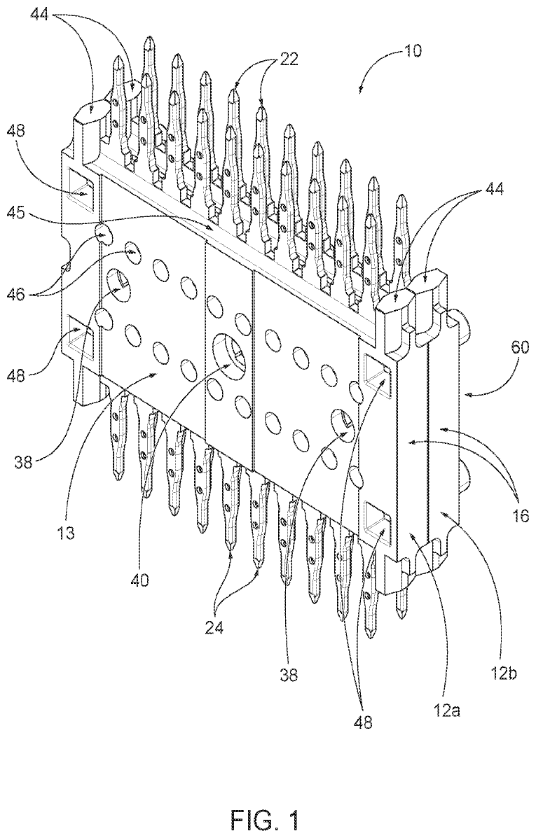

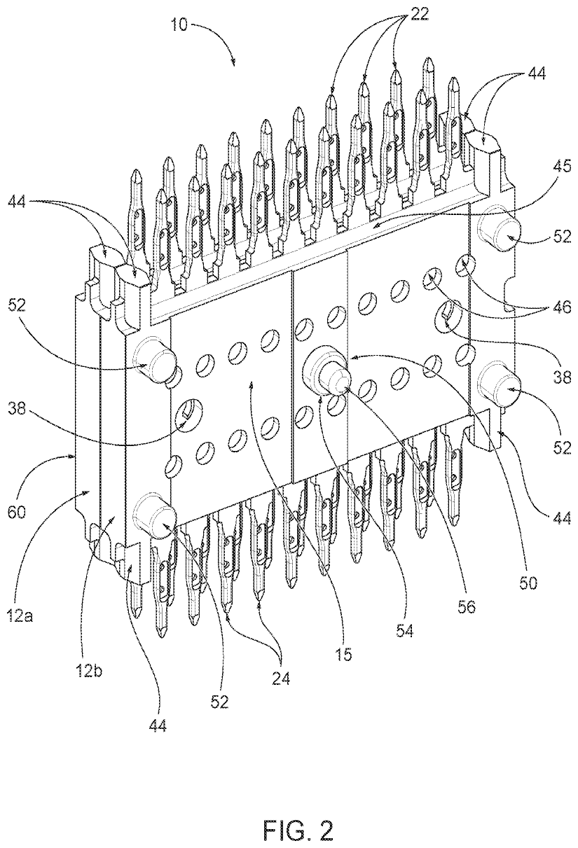

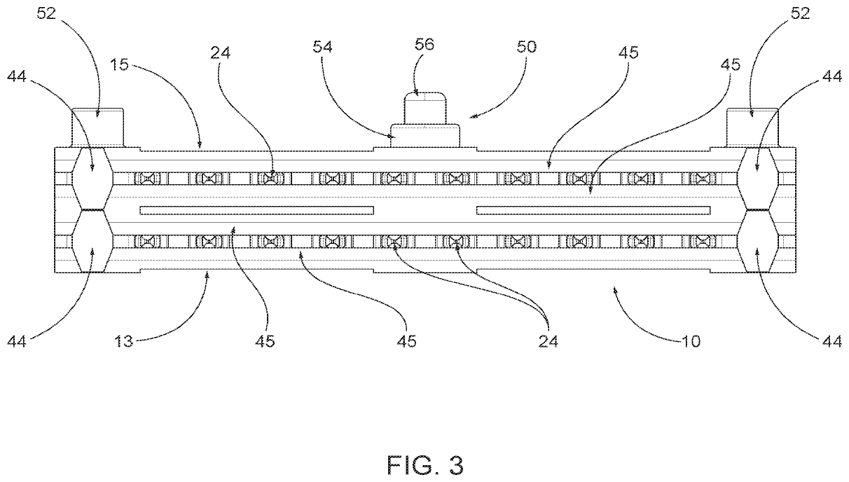

Referring now to FIGS. 1-5, there is shown a connector assembly 10 that generally includes a plurality of terminal wafers connected together to form a brick or biscuit of connectors. As will be appreciated from the following description, the connector assembly 10 is especially constructed for use as a standalone connector, i.e., it is not intended to be mounted inside an outer housing. As shown, the terminal wafers 12 may have the same construction. In other embodiments, however, the terminal wafers may have different constructions. In the shown embodiment, a first terminal wafer 12a is connected to a second terminal wafer 12b such that a rear side 15 of the first terminal wafer 12a adjoins a front side 13 of the second terminal wafer 12b.

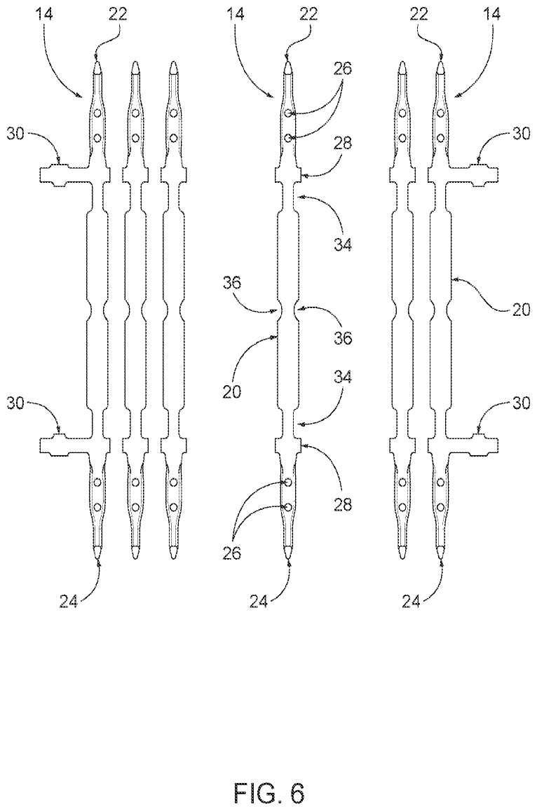

Each terminal wafer 12 includes a plurality of elongated metal terminals 14 that are spaced-apart and held in position relative to each other by a body 16 formed from plastic that is molded over the terminals 14. Each terminal 14 is formed from an electrically conductive metal, such as copper or a copper alloy, which may or may not be plated with another metal, such as tin or nickel. As shown in FIG. 6, each terminal 14 includes a middle section 20 joined between upper and lower press-fit fasteners 22, 24, which may have an eye-of-the-needle (EON) construction. In this type of construction, an opening or piercing is formed in the fastener so as to define a pair of beams that are resiliently movable toward and away from each other to provide a normal force against the PCB hole. Another type of construction that may be used for the press-fit fasteners 22, 24 utilizes beams that are connected together by a web that permits the beams to roll inward to conform to the PCB hole. A particularly suitable web-type of construction that may be used for the press-fit fasteners 22, 24 is shown in U.S. Patent Publication No. 20200280144 to Parrish, which is herein incorporated by reference. In this construction, each fastening section includes a pair of beams with a web joined in-between. The web has a center portion disposed between a pair of sloping ramp portions. A pair of holes 26 may extend through the center portion.

In each terminal 14, each of the upper and lower press-fit fasteners 22, 24 is joined to the middle section 20 of the terminal 14 by a pair of shoulders 28. In the two outermost terminals 14, an arm 30 extends laterally outward from each of the outer shoulders 28. Each pair of shoulders 28 of each terminal 14 are joined to the middle section by narrow necks 34. At about the center of each middle section 20 of each terminal 14, a pair of aligned depressions 36 are formed in opposing sides of the middle section 20.

Each terminal wafer 12 may be formed by a process that utilizes a unitary or monolithic stamping containing a row of terminals 14. The terminals 14 are connected together by upper and lower tie bars. The body 16 is over-molded over the stamping using a molding tool that may include a pair of outer holding pins and a center holding pin. The holding pins extend through the depressions 36 in pairs of adjacent terminals 14. A first pair of the adjacent terminals 14 may be on one side of the row of terminals 14 and a second pair of the adjacent terminals 14 may be on the other side of the row of terminals 14. A third pair of the adjacent terminals 14 may be in the center of the row of terminals 14. After the over-molding of the body 16, the holding pins are removed, leaving a pair of outer through-holes 38 and a center socket 40 in the body 16. In addition, the tie bars are cut or punched to separate the terminals 14 and form the shoulders 28.

In the embodiment shown in FIGS. 1-5, each terminal wafer 12 contains ten terminals 14. Of course, the number of terminals 14 in a terminal wafer may be different, depending on the application. In addition, the number of terminals 14 may differ from terminal wafer to terminal wafer.

As shown in FIGS. 1-5, the body 16 of each terminal wafer 12 is generally rectangular and has front and rear sides 13, 15 and upper and lower ends. At each of the upper and lower ends, a pair of pedestals 44 extend outwardly from the body 16 and bracket the press-fit fasteners. The pedestals 44 at each end help support the connector assembly 10 on a PCB. The pedestals 44 are molded over the arms 30 of the outer terminals 14. Free ends of the pedestals 44 are flat so as to provide stable surfaces for stably supporting the connector assembly 10 between surfaces of PCBs when the upper and lower press-fit fasteners 22, 24 are inserted into plated holes of the PCBs. In this regard, the pedestals 44 are sized such that most of the length of the upper and lower press-fit fasteners 22, 24 extends outwardly farther than the pedestals 44. More specifically, the portions of the upper and lower press-fit fasteners 22, 24 that have the greatest deformation potential are disposed outward from the free ends of the pedestals 44 so as to permit them to be received in the plated holes of the PCBs. Thus, in each of the upper and lower press-fit fasteners 22, 24, both of the holes 26 are disposed outward from the free ends of the pedestals 44.

In each terminal wafer 12, the upper press-fit fasteners 22 extend from the upper end and are arranged in a row in a spaced-apart manner. The row is bracketed by a pair of strip surfaces 45 that extend continuously along the entire length of the row; one of the strip surfaces 45 is located toward the front side 13 and the other one of the strip surfaces 45 is located toward the rear side 15. The strip surfaces 45 are adjacent to the row of upper press-fit fasteners 22 and may be horizontal or sloping toward the side they are adjacent to.

In each terminal wafer 12, the lower press-fit fasteners 24 extend from the lower end and are arranged in a row in a spaced-apart manner. The row is also bracketed by a pair of strip surfaces 45 that extend continuously along the entire length of the row; one of the strip surfaces 45 is located toward the front side 13 and the other one of the strip surfaces 45 is located toward the rear side 15. The strip surfaces 45 are adjacent to the row of lower press-fit fasteners 24 and may be horizontal or sloping toward the side they are adjacent to.

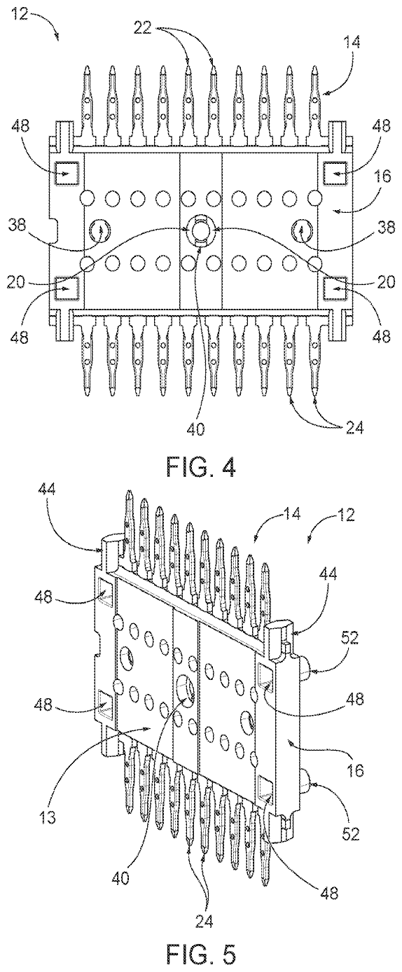

It should be noted that portions of the terminals 14 located inward from the upper and lower press-fit fasteners 22, 24 also project beyond the ends of the body 16 so as to be located outside the body 16, i.e. are exposed. This additional exposure allows the terminals 14 to flex to accommodate any misalignment between the positions of the terminals 14 at their exits from the body 16 and the positions of holes in the PCBs into which the upper and lower press-fit fasteners 22, 24 are to be inserted. For example, as best shown in FIG. 4, the shoulders 28 of the terminals are located outside the body 16 at the upper and lower ends of the body 16. This permits the terminals 14 to flex to accommodate misalignment.

The front side 13 of each body 16 has corner depressions or sockets 48 located at the four corners of the body 16, respectively. As shown, the corner sockets 48 may have a rectangular shape, with a width a little greater than its height. As such, these corner sockets 48 may be considered to have oblong rectangular shapes. The front side 13 also includes front openings for the through-holes 38 and an opening for the center socket 40. The through-holes 38 and the center socket 40 may be vertically bracketed by two series of holes 46. The holes 46 extend through the body 16; however, the middle sections 20 of the terminals 14 traverse the holes 46 and block through-passage of the holes 46 between the front and rear sides 13, 15.

The rear side 15 of each body 16 includes rear openings for the holes 46. These rear openings bracket rear openings of the through-holes 38 and a center plug 50. Posts 52 are located at the four corners of the body 16 and project outwardly. The center plug 50 is aligned with the center socket 40 on the front side 13 and the posts 52 are aligned with the corner sockets 48 on the front side 13. Moreover, the posts 52 are configured to be tightly received in the corner sockets 48 of the body 16 of another terminal wafer 12 and the center plug 50 is configured to be snugly received in the center socket 40 of the body 16 of another terminal wafer 12.

The posts 52 may be cylindrical and have a diameter slightly greater than the height of the rectangular corner sockets 48, which causes the posts 52 to deform slightly when they are inserted in the corner sockets 48, respectively. This deformation creates retaining forces that hold the posts 52 in the corner sockets 48 and thereby create snap-fit connections therebetween. The oblong rectangular shape of the corner sockets 48 permits the posts 52 to deform slightly.

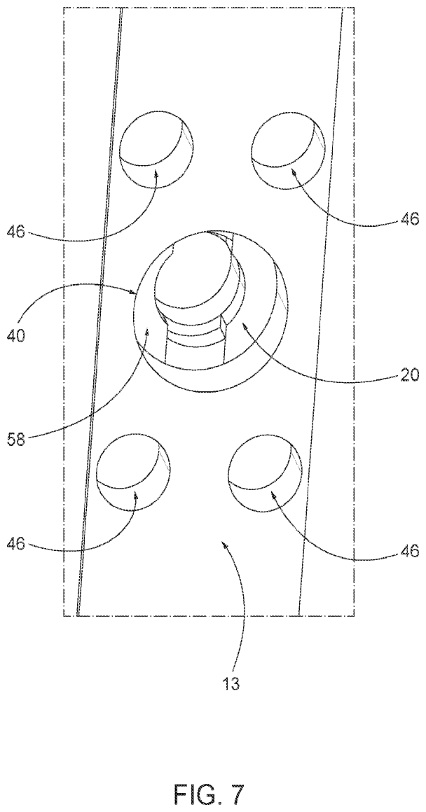

The center plug 50 has a cylindrical base 54 joined to a top cylindrical cap 56. The base 54 has a larger diameter than the cap 56 so as to give the center plug 50 a stepped configuration. The stepped configuration of the center plug 50 conforms with the stepped shape of the center socket 40, which has a wide portion located proximate to the front side 13 and a more narrow portion located proximate to the rear side 15, with the wide and narrow portions being separated by a ledge 58, as shown in FIG. 7. The ledge 58 includes opposing, depressed side portions that are arcuate in shape. These side portions receive arcuate portions of the middle sections 20 of the terminals 14 formed by the depressions 36 in the middle sections 20.

The first terminal wafer 12a is connected to the second terminal wafer 12b by aligning the posts 52 of the first terminal wafer 12a with the corner sockets 48 in the second terminal wafer 12b, respectively, and aligning the center plug 50 of the first terminal wafer 12a with the center socket 40 of the second terminal wafer 12b, and then pressing the first and second terminal wafers 12a,b together. The posts 52 snap into the corner sockets 48, respectively, and the center plug 50 presses into the center socket 40, thereby securing together the first and second terminal wafers 12a,b and forming the connector assembly 10.

The connector assembly 10 formed from the two terminal wafers 12a,b has two rows of upper press-fit fasteners 22 that project upwardly from a composite body 60 formed by the adjoining bodies 16 and two rows of lower press-fit fasteners 24 that project downwardly from the composite body 60. The upper press-fit fasteners 22 in one row are aligned with the upper press-fit fasteners 22 in the other row. Similarly, the lower press-fit fasteners 24 in one row are aligned with the lower press-fit fasteners 24 in the other row.

In the embodiment shown in FIGS. 1-5, the connector assembly 10 contains two terminal wafers 12a,b with a total of twenty terminals 14. Of course, the number of terminals 14 in a connector assembly may be different, depending on the application. In addition, the number of terminals 14 may differ from terminal wafer to terminal wafer. Further, additional terminal wafers 12 may be connected to the terminal wafers 12a,b to bring the total number of terminal wafers 12 to three, four, or more. For example, a third terminal wafer 12 may be connected to the first terminal wafer 12a by snapping the posts 52 of the third terminal wafer 12 into the corner sockets 48 of the first terminal wafer 12a and pressing the center plug 50 of the third terminal wafer 12 into the center socket 40 of the first terminal wafer 12a. A fourth terminal wafer 12 may be similarly connected to the second terminal wafer 12b.

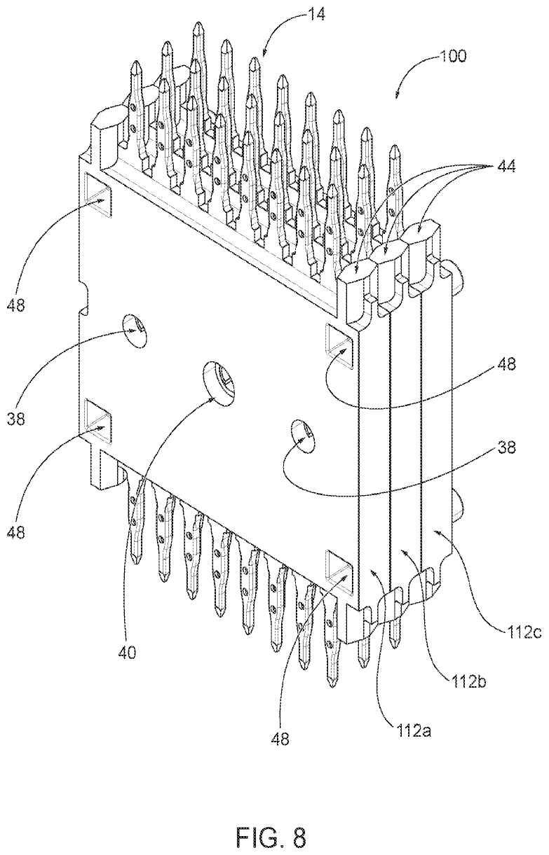

Another example of a connector assembly constructed in accordance with this disclosure is shown in FIG. 8. The shown connector assembly 100 includes three terminal wafers 112a,b,c connected together. Each terminal wafer 112a,b,c has the same construction as the terminal wafer 12, except for its dimensions and number of terminals 14. More specifically, each terminal wafer 112a,b,c is narrower and taller than the terminal wafer 12 and has only eight terminals 14, instead of ten as in the terminal wafer 12. Since the connector assembly 100 has three terminal wafers 12a,b,c and each terminal wafer 112a,b,c has eight terminals 14, the connector assembly 100 has a total of twenty-four terminals 14.

Generally, in embodiments of the present disclosure, connector assemblies may be formed from terminal wafers, each having from seven terminals 14 to up to thirty terminals 14. Moreover, in some embodiments, six terminal wafers may be connected together. Thus, in these embodiments, a connector assembly may have a total of from seven (7) terminals 14 up to one hundred eighty (180) terminals 14.

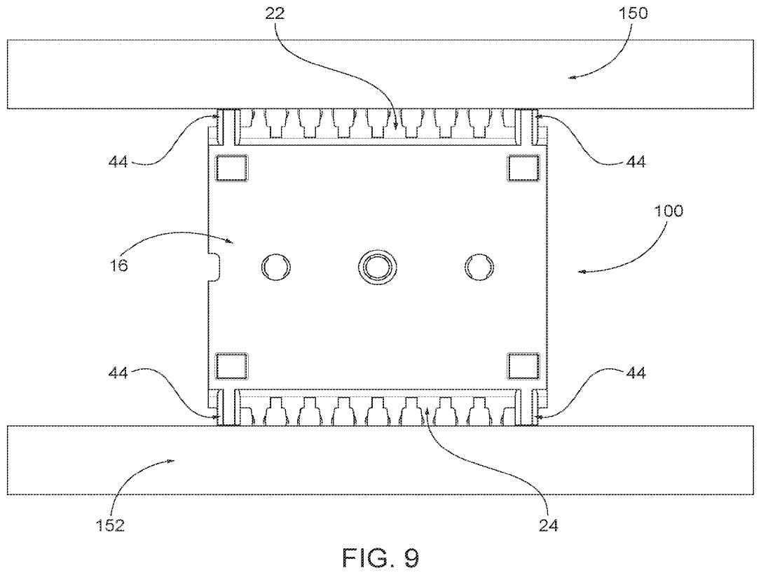

Each connector assembly 10, 100, by itself, may be used to connect together a pair of PCBs, such as the upper and lower PCBs 150, 152 shown in FIG. 9. The upper press-fit fasteners 22 are pressed into plated holes of the upper PCB 150, while the lower press-fit fasteners 24 are pressed into the plated holes of the lower PCB 152, thereby connecting together the upper and lower PCBs 150, 152 both electrically and mechanically. The pedestals 44 at the upper end of the connector assembly 10, 100 press against the planar surface of the upper PCB 150, while the pedestals 44 at the lower end of the connector assembly 10 press against the planar surface of the lower PCB 152. In being so positioned, the connector assembly 10, 100 extends between, and is disposed perpendicular to, the upper and lower PCBs 150, 152.

Some of the benefits of using the disclosed terminal wafers to form connector assemblies, include: (1.) allowing the same wafer to be used to form different connector assemblies, thereby simplifying manufacture and (2.) allowing connector assemblies to be formed having smaller pitches, i.e., smaller distances between the terminals.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

1. A connector assembly for connecting together parts to convey electrical signals in-between, the connector assembly comprising:
a plurality of terminal wafers mechanically connected together, each of the terminal wafers comprising:
a plurality of terminals, each terminal including a first press-fit fastener joined to a second press-fit fastener by a linearly-extending main section such that the first and second press-fit fasteners extend in opposing directions;
a body comprising plastic molded over the terminals, the body having first and second sides extending between first and second ends, wherein the first side comprises a plurality of sockets and the second side comprises a plurality of outwardly-extending plugs, and wherein the first press-fit fasteners project from the first end and the second press-fit fasteners project from the second end; and
wherein the terminal wafers are connected together by having the plugs of one or more terminal wafers inserted into the sockets of one or more other terminal wafers, respectively.

2. The connector assembly of claim 1, wherein each of the terminal wafers comprise at least six terminals.

3. The connector assembly of claim 2, wherein the connector assembly comprises a total of from seven to one hundred eighty terminals.

4. The connector assembly of claim 1, wherein the first press-fit fasteners are arranged in a single row and the second press-fit fasteners are arranged in a single row.

5. The connector assembly of claim 4, wherein the body comprises a pair of first strip surfaces, each of which extends uninterrupted for the entire length of the row of the first press-fit fasteners, and wherein the row of the first press-fit fasteners is disposed adjacent to and between the first strip surfaces.

6. The connector assembly of claim 5, wherein the body comprises a pair of second strip surfaces, each of which extends uninterrupted for the entire length of the row of the second press-fit fasteners, and wherein the row of the second press-fit fasteners is disposed adjacent to and between the second strip surfaces.

7. The connector assembly of claim 1, wherein in each of the terminal wafers, the sockets of the first side are aligned with the plugs of the second side.

8. The connector assembly of claim 1, wherein a pair of adjacent first terminals have depressions formed therein, respectively, the depressions facing each other and forming arcuate portions of the first terminals adjacent to the depressions, respectively.

9. The connector assembly of claim 8, wherein a first one of the sockets extends between the arcuate portions of the first terminals.

10. The connector assembly of claim 9, wherein the first one of the sockets has two portions with different diameters so as to form a ledge in-between, the ledge having opposing portions that abut the arcuate portions of the first terminals, respectively.

11. The connector assembly of claim 8, wherein a pair of adjacent second terminals have depressions formed therein, respectively, the depressions facing each other and forming arcuate portions of the second terminals adjacent to the depressions, respectively, and wherein a second one of the sockets extends between the arcuate portions of the second terminals.

12. The connector assembly of claim 1, wherein the plugs inserted into the sockets together form snap-fit connections.

13. The connector assembly of claim 1, wherein portions of the main sections of the terminals project beyond the body to permit the terminals to flex to accommodate any misalignment between positions of the terminals where they exit the body to positions on a part where the first press-fit fasteners or the second press-fit fasteners are to be connected.

14. The connector assembly of claim 1, wherein the connector assembly comprises first, second and third terminal wafers, and wherein the second terminal wafer is disposed between and adjoins the first and third terminal wafers.

15. The connector assembly of claim 1, wherein the connector assembly comprises three or more terminal wafers.

16. The connector assembly of claim 1, wherein the body further comprises a pair of first pedestals projecting from the first end of the body and a pair of second pedestals projecting from the second end of the body, and wherein the first pedestals bracket the first press-fit fasteners and the second pedestals bracket the second press-fit fasteners.

17. The connector assembly of claim 16, wherein the first pedestals are sized such that most of the lengths of the first press-fit fasteners extend outwardly farther than the first pedestals, and wherein the second pedestals are sized such that most of the lengths of the second press-fit fasteners extend outwardly farther than the second pedestals.

18. A circuit board assembly comprising the connector assembly of claim 17 and first and second circuit boards having plated holes, wherein the first press-fit fasteners are secured in the plated holes of the first circuit board and the second press-fit fasteners are secured in the plated holes of the second circuit board, and
wherein the first pedestals press against a planar surface of the first circuit board and the second pedestals press against a planar surface of the second circuit board.

19. A circuit board assembly comprising the connector assembly of claim 1 and first and second circuit boards having plated holes, wherein the first press-fit fasteners are secured in the plated holes of the first circuit board and the second press-fit fasteners are secured in the plated holes of the second circuit board, and
wherein top portions of the body press against a planar surface of the first circuit board and bottom portions of the body press against a planar surface of the second circuit board.

20. The circuit board assembly of claim 19, wherein the top portions pf the body comprise a pair of first pedestals projecting from the first end of the body, and wherein the bottom portions of the body comprise a pair of second pedestals, and wherein the first pedestals bracket the first press-fit fasteners and the second pedestals bracket the second press-fit fasteners.
